(19) United States
(12) Patent Application Publication
(10) Pub. No.: US 2010/0110014 A1
(43) Pub. Date: May 6, 2010

(54) KEYPUNCH

(76) Inventor: Cynthia V. DAYHOFF, Americus, GA (US)

Correspondence Address: ARENT FOX LLP, 1050 CONNECTICUT AVENUE, N.W., SUITE 400, WASHINGTON, DC, 20036, US

(21) Appl. No.: 12/582,055

(22) Filed: Oct. 20, 2009

Related U.S. Application Data
(60) Provisional application No. 61/111,468, filed on Nov. 5, 2008.

(51) Int. Cl. G06F 3/02

(52) U.S. Cl. 345/169

(57) ABSTRACT

A device for aiding a user while entering data on a handheld keypad. The device may have a band with a protuberance that the user may wear while entering data on a handheld device. The device may be worn, for example, on a user's thumb with the protuberance in the center of the user's thumb pad. The protuberance may be used to press the keys on the handheld device.

### BACKGROUND OF THE INVENTION

1. Field of Invention

Aspects of the present invention relate to devices for aiding users when entering information on handheld devices. Specifically, aspects of the present invention are directed toward a band with a protuberance the user may wear while entering information with the keypad of a handheld device.

2. Description of Related Art

Handheld devices including Personal Digital Assistants (PDAs), mobile handheld devices and handheld computers, among others, are becoming a common technology used at work, for recreational purposes, and even in schools. Various health issues are arising due to the increased use of handheld devices. The use of handheld devices more than a few times a day may incur repetitive stress injuries to users' thumbs. Further, users may injure their thumbs or experience chronic pain when trying to bend their thumbs to type on the handheld device. Difficulties also arise with keys being too small for the user to press.

An additional problem that exists in the art today when entering information or typing on handheld devices is that adjacent keys, due to their close proximity, may be pressed accidentally causing misspelling of words or incorrect numbers. This often requires the user to correct the misspelled word or incorrect number and retype the letter or number.

Furthermore, the lettering on the keys can wear off causing difficulties in determining the letters and numbers. This wear and tear can be due to the oils from the user's fingers rubbing against the keys after prolonged use of the keypad.

There is a need in the art, therefore, for a device that assists a user in increasing accuracy when entering information on handheld devices. In addition, there is a need in the art for a device to help eliminate stress on the user's hands when typing. Further, there is a need in the art for a device that aids a user in pressing the correct keys on a handheld device. Moreover, there is a need in the art for a device that helps prevent the wear and tear of the keypad of a handheld device due to prolonged use.

### SUMMARY OF THE INVENTION

In light of the above described problems and unmet needs, aspects of the present invention provide a device for aiding a user while entering information on a handheld device. In one variation, aspects of the present invention may include a preformed band with a protuberance in the center of the outer side of the band. The shape of the band may be cylindrical, among others. The user may wear the device while typing on a handheld device. For example, the device may be worn on a user's thumb with the protuberance in the center of the user's thumb.

In another variation, aspects of the present invention may include a strip that forms a band around the user's finger with a protuberance on the outer side of the strip in the center.

Aspects of the present invention provide benefits and advantages that include relieving the stress placed on the user's thumbs while typing on handheld devices. Additionally, aspects of the present invention provide increased accuracy while typing by preventing the possibility of accidentally pressing nearby numbers or letters.

Additionally, the present invention may be modified to fit individuals with various finger sizes. Further, the present invention may be used in connection with any type of handheld device. For example, the present invention may be used with cellular telephones, Blackberries, Treos, Sidekicks, Palms, PDAs, MP3 Players, and handheld computers, among others.

Yet another aspect of the present invention relates to protecting the handheld device from wear and tear. For example, the user's skin may be prevented from having direct contact with the device, thus preventing the oils on the user's skin from rubbing onto the handheld device. This may help prevent the spread of disease among multiple users of a handheld device, and may protect the keys of the handheld device from wearing out.

Additional advantages and novel features relating to the present invention will be set forth in part in the description that follows, and in part will become more apparent to those skilled in the art upon examination of the following or upon learning by practice of aspects of the invention.

### BRIEF DESCRIPTION OF THE DRAWINGS

Various exemplary embodiments of the systems and methods will be described in detail, with reference to the following figures, wherein:

FIGS. 1A, 1B and 1C present an exemplary device according to an aspect of the present invention.

FIG. 2 presents an exemplary device in accordance with an aspect of the present invention.

FIG. 3 illustrates a high-level depiction of a device in accordance with an aspect of the present invention.

FIG. 4 illustrates a high-level depiction of a device in accordance with an aspect of the present invention.

FIG. 5 illustrates a high-level depiction of a device in accordance with an aspect of the present invention.

### DETAILED DESCRIPTION OF PREFERRED EMBODIMENTS

Aspects of the present invention will be described more fully with reference to the accompanying drawings, in which variations and features of the present invention are shown. Aspects of the present invention may, however, be realized in many different forms and should not be construed as limited to the variations set forth herein; rather, these variations are provided so that this disclosure will be thorough and complete in the illustrative implementations, and will fully convey the scope thereof to those skilled in the art.

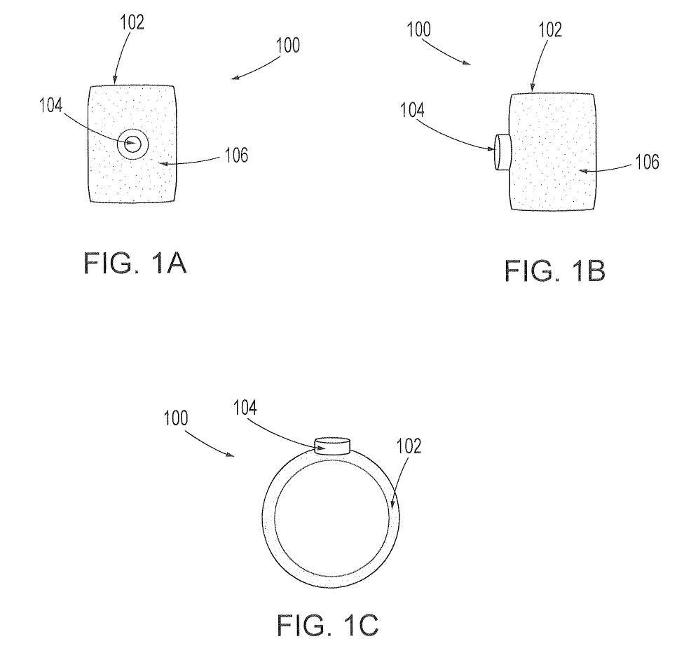

FIGS. 1A, 1B and 1C provide a pictorial representation of an exemplary variation of device 100. As illustrated, device 100 may comprise a preformed band 102 of flexible material 106 and a protuberance 104. It should be appreciated that the shape of the band may be cylindrical, among others. The flexible material 106 may be any material that is durable and sturdy. For example, the flexible material 106 may include a thick rubber band, a neoprene band, fabric, elastic, spandex or velcro, among others. It should be appreciated that band 102 may come in various shapes and sizes to fit the users' fingers. Further, it should be appreciated that band 102 may fit snugly on the user's finger in order to keep the device in the same position on the user's finger.

Protuberance 104 may be located on one side of the flexible material 106. In addition, protuberance 104 may be positioned in the center of band 102. It should be appreciated that protuberance 104 may be positioned in various locations on band 102. Among others, protuberance 104 may be located on band 102 where protuberance 104 may be centered on the user's thumb pad.

Moreover, protuberance 104 may be a nub or any form of protrusion. It should be appreciated that protuberance 104 may be of various shapes and sizes. For example, protuberance 104 may be a square, circle, the shape of a nail head, diamond, oval, or pyramid, among others. In addition, protuberance 104 may be made of a solid but flexible material. For example, protuberance 104 may be rubber or plastic, among others.

Further, protuberance 104 may be affixed to band 102 in a variety of methods. For example, protuberance 104 may be attached with an adhesive material, may be sewn to the band 102, or may be formed as part of band 102, among others.

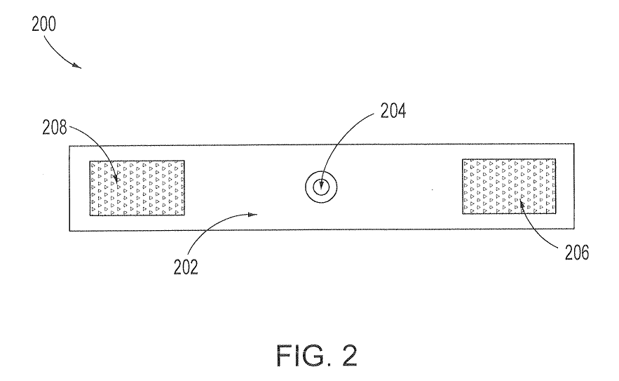

FIG. 2 illustrates an aspect of the present invention, in which the device 200 may comprise an adjustable band 202. Adjustable band 202 may be made of various materials that are flexible and durable. For example, the material may include a thick rubber band, a neoprene band, fabric, denim, elastic, spandex or velcro, among others.

Adjustable band 202 may be varied to fit various users' fingers. In an aspect of the present invention, adjustable band 202 may have securing mechanisms 206 and 208 for connecting the adjustable band 202 together and for securing the adjustable band 202 around a user's finger. It should be appreciated that securing mechanisms 206 and 208 may be made of velcro, adhesive materials, tape, buttons, or snaps, among others. It should also be appreciated that the adjustable band 202 may come in various sizes. For example, the adjustable band 202 may be small, medium, or large, among others.

In an aspect of the present invention, adjustable band 202 may have a protuberance 204. Protuberance 204 may be affixed to the outer side of adjustable band 202 in various positions. For example, protuberance 204 may be on the thumb pad of a user's finger. Moreover, protuberance 204 may be of various sizes and shapes. For example, protuberance 204 may be a square, circle, oval, or the shape of a nail head, among others. In an aspect of the present invention, protuberance 204 may be made of a sold and/or flexible material. The flexible material may include, among others, plastic or rubber.

Further, protuberance 204 may be attached to band 202 in a variety of methods. For example, protuberance 204 may be attached with an adhesive material, may be sewn on to band 202, or may be formed as part of band 202, among others.

It should be appreciated that a pad may be inserted between the protuberance and the material of the band. This may allow for added comfort for the user while typing on the handheld device. Additionally, padding may be added under the band between the user's finger and the band under the location of the protuberance.

Further, an additional layer of material may be added over the protuberance to add additional padding and/or prevent the protuberance from damaging the handheld device if the material of the protuberance is one that might scratch the keys. In addition, the additional layer of padding may provide added comfort for the user while typing on the handheld device.

It should also be appreciated aspects of the present invention may be made out of disposable materials. The user may use the device once, or multiple times, and then dispose the device.

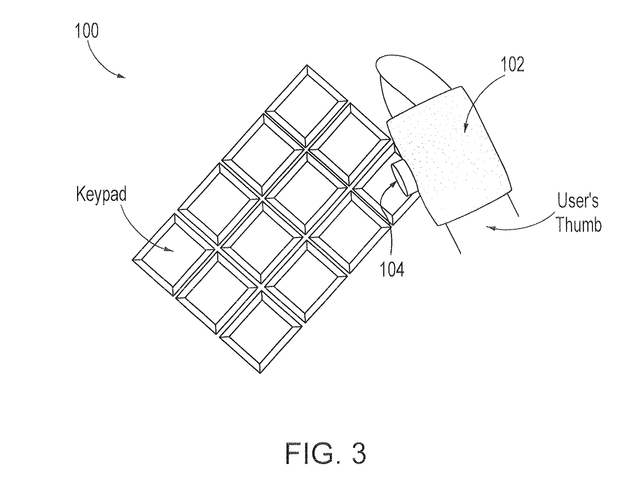

FIGS. 3, 4 and 5 show the device 100 of FIG. 1, with the band 102 secured around user's thumb. Furthermore, FIGS. 3, 4 and 5 illustrate how the device 100 may be used to type on the handheld device. FIG. 3 shows how the protuberance 104 may be used to press key 302.

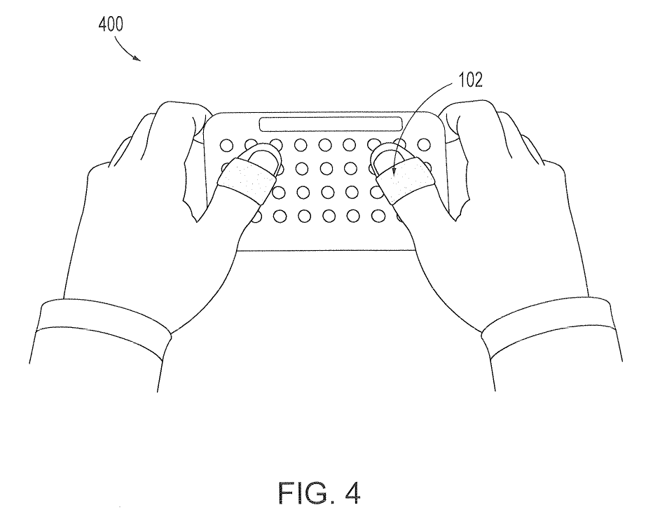

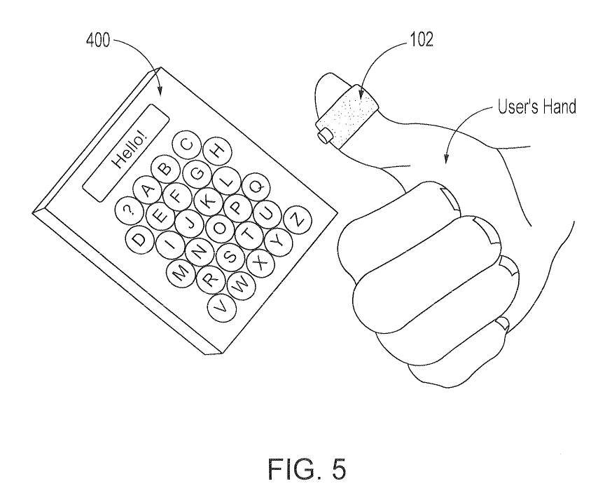

FIG. 4 shows that the user may wear device 100 on both thumbs. It should be appreciated that the user may wear device 100 on multiple fingers on one hand in addition to wearing device 100 on both hands. FIG. 4 also illustrates an example of how the user may hold the handheld device while typing using device 100. FIG. 5 shows an example of a word that may be typed using device 100.

In accordance with another aspect of the present invention, the device may alternatively comprise a preformed cap partially or fully covering a user's finger. The device of this variation may be capable of sliding onto a user's finger and fitting snuggly over the user's finger. Further, having a preformed cap may allow the protuberance to be located on the tip of the user's finger, among other locations on the user's finger.

In accordance with yet another aspect of the present invention, the device may include a connector line operationally connected between multiple devices of the present invention (e.g., a line connecting two devices together). The connector line may be, for example, an elastic band, a rope, or an insulated wire, among other connecting lines. In one aspect, the connector line is preformed into the band of each device. For example, an outer portion of a first band may have one end of the connector line preformed into the band, while an outer portion of a second band may have the other end of the connector line preformed into the band. Thus, the two devices are connected together preventing the loss of a single device.

In an alternative aspect, the ends of the connector line may be removably connected between two or more devices of the present invention. For example, one or both ends of the connector line may have connecting elements, either preformed thereon, or attached thereto via known attachment methods. The connector elements may be inserted into an aperture in the side portion of the band. It should be appreciated that the aperture may be in a “C” shape, a “T” shape, or an “L” shape, among other shapes capable of holding the connecting element inserted through the aperture to keep the connecting element in place. Allowing the connector line to optionally be connected to the devices provides the user of the device flexibility in connecting and disconnecting devices to one another.

It should be appreciated that the connector line may be used to wrap the devices around the handheld device after the user is finished typing on the handheld device.

Aspects of the present invention have been described in terms of several variations and illustrative examples, it will be obvious that the same may be varied in many ways. Moreover, while numerous aspects of the devices of the present invention have been described in relation to typing on handheld devices, it is within the scope of the present invention to apply the devices with any type of keyboard or keypad for the reasons explained above. Other aspects will be apparent to those skilled in the art from a consideration of the specification and the described examples are considered exemplary only. Such variations are not to be regarded as a departure from the spirit and scope of the described aspects, and to incorporate such modifications as would be obvious to one skilled in the art.

What is claimed is:

1. A device comprising:
a preformed band; and
a protuberance, wherein the protuberance is attached to the outer side of the band;
wherein the device is adapted to assist with entering data on a handheld device by making contact between the protuberance and a key of the handheld device.

2. The device of claim 1, wherein the protuberance is attached to the center of the preformed band.

3. The device of claim 1, wherein a shape of the protuberance includes one selected from a group consisting of: square, diamond, circle, oval, and pyramid.

4. The device of claim 1, further comprising:
a pad attached on the outer side of the preformed band in the center.

5. The device of claim 4, wherein the protuberance is attached to the pad.

6. The device of claim 1, wherein a material of the protuberance includes one selected from a group consisting of: plastic and rubber.

7. The device of claim 1, wherein a material of the preformed band includes one selected from a group consisting of: neoprene, fabric, elastic, spandex, velcro, and rubber.

8. The device of claim 1, wherein a size of the preformed band includes one selected from a group consisting of: small, medium, and large.

9. A device comprising:
a strip with a first end and a second end, wherein the first end and the second end are connected to form an adjustable band; and
a protuberance attached to the outer side of the strip;
wherein the device is adapted to assist with entering data on a handheld device by making contact between the protuberance and a key of the handheld device.

10. The device of claim 9, wherein the first end and the second end have velcro upon a side thereof.

11. The device of claim 9, wherein the first end and the second end have an adhesive material upon a side thereof.

12. The device of claim 9, wherein the protuberance is attached to the center of the strip.

13. The device of claim 9, further comprising:
a pad attached to the outer side of the strip in the center.

14. The device of claim 13, wherein the protuberance is attached to the pad.

15. The device of claim 9, wherein a material of the strip includes one selected from the group consisting of: velcro, fabric, denim, neoprene, rubber, elastic, and spandex.

16. The device of claim 9, wherein a material of the protuberance includes one selected from a group consisting of: plastic and rubber.

17. A method for entering data on a handheld device comprising a plurality of keys and an interface, the method comprising:
applying pressure to one of the plurality of keys via a first protuberance attached to an outer side of a first band;
displaying, via an interface, data corresponding to the key pressed via the first protuberance;
applying pressure to one of the plurality of keys via a second protuberance attached to an outer side of a second band; and
displaying, via the interface, data corresponding to the key pressed via the second protuberance.
